(19) United States
(12) Patent Application Publication
(10) Pub. No.: US 2007/0181640 A1
(43) Pub. Date: Aug. 9, 2007

(54) LEAD-FREE SOLDER REWORKING SYSTEM AND METHOD THEREOF

(75) Inventors: Wen-Chi Chen, Kuei Shan Hsiang (TW); Jauwhei Hong, Kuei Shan Hsiang (TW)

Correspondence Address: Daniel R. McClure;Thomas, Kayden, Horstemeyer & Risley LLP, 100 Galleria Parkway, Suite 1750, Atlanta, GA, 30339, US

(73) Assignee: Quanta Computer Inc., Tao Yuan Shien (TW)

(21) Appl. No.: 11/380,224

(22) Filed: Apr. 26, 2006

(30) Foreign Application Priority Data
Feb. 3, 2006 (TW) 95103767

(51) Int. Cl. A47J 36/02

(52) U.S. Cl. 228/101

(57) ABSTRACT

A lead-free solder reworking method. A solder tank including a nozzle and containing molten lead-free solder is provided. A printed circuit board assembly is placed on the solder tank. The printed circuit board assembly has a printed circuit board and a first electronic member. The printed circuit board has at least one through hole. The first electronic member has at least one first pin soldered in the through hole by lead-free solder. The through hole and first pin are located above the nozzle. A reworking temperature and a reworking time are established. The printed circuit board is heated until the temperature thereof reaches the reworking temperature. The nozzle outputs the molten lead-free solder from the solder tank to the through hole of the printed circuit board until the nozzle operates for the reworking time.

### BACKGROUND OF THE INVENTION

1. Field of the Invention

The invention relates to a lead-free solder reworking method, and in particular to a lead-free solder reworking method improving through hole solder fill of lead-free solder while protecting the structure of a printed circuit board.

2. Description of the Related Art

When an electronic member is combined with a printed circuit board (PCB), pins of the electronic member are fit into corresponding through holes of the PCB in advance. Molten solder is then filled in the through holes, connecting the pins of the electronic member to the PCB.

When the electronic member connected to the PCB is damaged and needs to be replaced, a reworking process is often performed. The PCB with the damaged electronic member is placed above a solder tank containing molten solder. The high-temperature molten solder is output from the solder tank and melts solder in the through holes, such that the damaged electronic member can be removed from the PCB. A replacement electronic member is connected to the PCB (namely, the pins thereof are fit into the through holes of the PCB). The PCB is then separated from the solder tank, completing the reworking process.

Compared to lead-free solder, leaded solder provides a low melting point (about 183° C.). After the pins of the replacement electronic member are fit into the through holes of the PCB, the leaded solder output from the solder tank easily fills the entire through holes.

For environmental consideration, lead-free solder, such as SAC (Sn/Ag/Cu) alloy, is commonly used. The lead-free solder with a high melting point (about 217° C.-220° C.), however, causes some problems in the reworking process. Specifically, having a high melting point, the lead-free solder often solidifies before thoroughly filling in the through holes, thus not complying with regulations of through hole solder fill of the IPC standard, which asserts that solder must occupy at least 75% space of a through hole. Accordingly, in a conventional reworking process, output of the molten lead-free solder from the solder tank is prolonged, such that the molten lead-free solder does not easily solidify due to reduced temperature. Thus, the molten lead-free solder easily fills in the entire through holes.

The conventional reworking process, however, has some drawbacks. Walls of the plated through holes of the PCB are coated with a layer of copper, serving as an interconnection interface among various circuit layers in the PCB and conducting different circuit layers therein. Prolonged output of the molten lead-free solder from the solder tank melts the layer of copper coated on the walls of the through holes, thereby causing open circuit in the PCB or even damage to the inner structure of the PCB. Furthermore, the prolonged output of the molten lead-free solder from the solder tank results in persistent high temperature, thus deforming or warping the PCB.

### BRIEF SUMMARY OF THE INVENTION

A detailed description is given in the following embodiments with reference to the accompanying drawings.

An exemplary embodiment of the invention provides a lead-free solder reworking method comprising providing a solder tank comprising a nozzle and containing molten lead-free solder, placing a printed circuit board assembly on the solder tank, wherein the printed circuit board assembly has a printed circuit board and a first electronic member, the printed circuit board has at least one through hole, the first electronic member has at least one first pin soldered in the through hole by means of lead-free solder, and the through hole and first pin are located above the nozzle, heating the printed circuit board until the temperature thereof reaches the reworking temperature, and actuating the nozzle, outputting the molten lead-free solder from the solder tank to the through hole of the printed circuit board until the nozzle operates for the reworking time.

The lead-free solder reworking method further comprises, after actuating the nozzle, removing the first electronic member from the printed circuit board, and connecting a second electronic member to the printed circuit board. The second electronic member has at least one second pin fit into the through hole.

The lead-free solder reworking method further comprises providing a controller controlling the reworking temperature and reworking time.

The lead-free solder reworking method further comprises providing a heater heating the printed circuit board. The heater is electrically connected to the controller.

The heater comprises a hot-air solder cleaning device.

The lead-free solder reworking method further comprises providing a temperature sensing member detecting the temperature of the printed circuit board. The temperature sensing member is connected to the printed circuit board and electrically connected to the controller.

The temperature sensing member is connected to the surface of the printed circuit board.

The lead-free solder reworking method further comprises providing a monitor electrically connected to the controller.

Another exemplary embodiment of the invention provides a lead-free solder reworking system comprising a controller, a solder tank, at least one heater, and a temperature sensing member. The solder tank is electrically connected to the controller and comprises a nozzle. The solder tank contains molten lead-free solder. The heater is electrically connected to the controller, heating a printed circuit board assembly. The printed circuit board assembly has a printed circuit board and a first electronic member. The printed circuit board has at least one through hole. The first electronic member has at least one pin soldered in the through hole by means of lead-free solder. The through hole and pin are located above the nozzle. The temperature sensing member is connected to the printed circuit board and electrically connected to the controller.

The heater comprises a hot-air solder cleaning device opposing the nozzle.

The temperature sensing member is connected to the surface of the printed circuit board.

The lead-free solder reworking system further comprises a monitor electrically connected to the controller.

### BRIEF DESCRIPTION OF THE DRAWINGS

The invention can be more fully understood by reading the subsequent detailed description and examples with references made to the accompanying drawings, wherein:

FIG. 1 is a schematic view of a lead-free solder reworking system of the invention;

FIG. 2 is a schematic view of another lead-free solder reworking system of the invention; and

FIG. 3 is a flowchart showing a lead-free solder reworking method of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

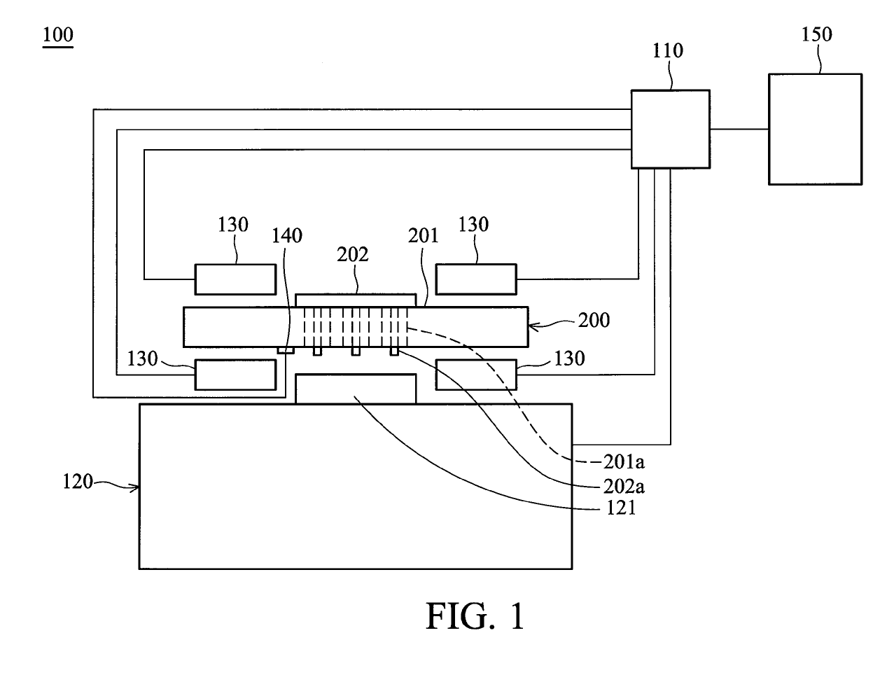

FIG. 1 is a schematic view of a lead-free solder reworking system 100. The lead-free solder reworking system 100 comprises a controller 110, a solder tank 120, a plurality of heaters 130, a temperature sensing member 140, and a monitor 150.

The solder tank 120 is electrically connected to the controller 110 and comprises a nozzle 121. Additionally, the solder tank 120 contains molten lead-free solder (not shown).

The heaters 130 are electrically connected to the controller 110. The heaters 130 may be radiation or convection heaters. Moreover, the number and position of the heaters 130 are not specified.

The temperature sensing member 140 and monitor 150 are electrically connected to the controller 110.

The following description is directed to lead-free solder reworking of a printed circuit board assembly using the lead-free solder reworking system 100.

As shown in FIG. 1, a printed circuit board assembly 200, which requires reworking, is placed on the solder tank 120. The printed circuit board assembly 200 has a printed circuit board 201 and at least one first electronic member 202. The printed circuit board 201 has a plurality of through holes 201a. The first electronic member 202 has a plurality of first pins 202a respectively soldered in the through holes 201a by means of lead-free solder (not shown). Specifically, when the printed circuit board assembly 200 is placed on the solder tank 120, the through holes 201a and first pins 202a are located above the nozzle 121 of the solder tank 120.

The temperature sensing member 140 is connected to the (top or bottom) surface of the printed circuit board 201. For example, the temperature sensing member 140 may be a thermal couple connected to the top surface of the printed circuit board 201.

A reworking temperature and a reworking time are established in the controller 110. The controller 110 then actuates the heaters 130 to heat the printed circuit board 201. The temperature sensing member 140 simultaneously detects the temperature of the (top) surface of the printed circuit board 201 and transmits the value thereof to the controller 110. The value of the temperature of the (top) surface of the printed circuit board 201 is then displayed on the monitor 150. When the temperature of the (top) surface of the printed circuit board 201 reaches the established reworking temperature, the controller 110 controls the heaters 130 to maintain the temperature of the printed circuit board and actuates the nozzle 121. The nozzle 121 outputs the molten lead-free solder from the solder tank 120 to the through holes 201a of the printed circuit board 201. At this point, the lead-free solder in the through holes 201a melts and the first electronic member 202 can be removed from the printed circuit board 201. A second electronic member (not shown) is then connected to the printed circuit board 201. Namely, multiple second pins (not shown) of the second electronic member are respectively fit into the through holes 201a. After the nozzle 121 operates for the reworking time, the controller 110 stops the nozzle 121. At this point, the molten lead-free solder fills in the entire through holes 201a. The reworked printed circuit board assembly is then separated from the solder tank 120, completing a lead-free solder reworking process.

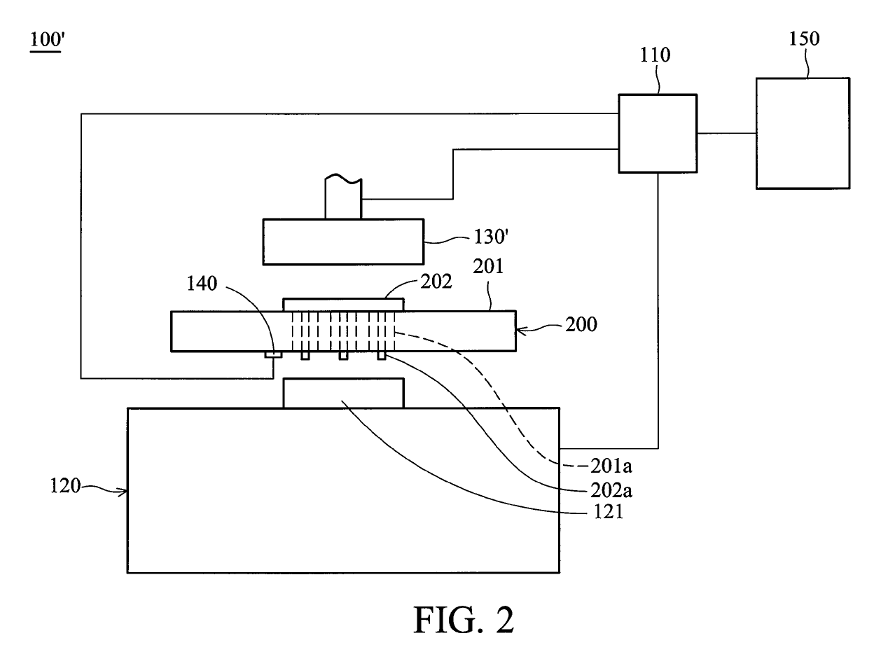

FIG. 2 is a schematic view of another lead-free solder reworking system 100′. Elements corresponding to those in the lead-free solder reworking system 100 share the same reference numerals, and explanation thereof is omitted for simplification of the description.

The lead-free solder reworking system 100′ comprises a controller 110, a solder tank 120, a hot-air solder cleaning device 130′, a temperature sensing member 140, and a monitor 150.

As shown in FIG. 2, the hot-air solder cleaning device 130′ opposes the nozzle 121. The hot-air solder cleaning device 130′, in its original use, provides hot air to dispel redundant solder from a printed circuit board assembly. In the lead-free solder reworking system 100′, the hot-air solder cleaning device 130′, in its extended use, serves as a heater and is controlled by the controller 110.

As lead-free solder reworking of a printed circuit board assembly using the lead-free solder reworking system 100′ is the same as that using the lead-free solder reworking system 100, description thereof is omitted for simplicity.

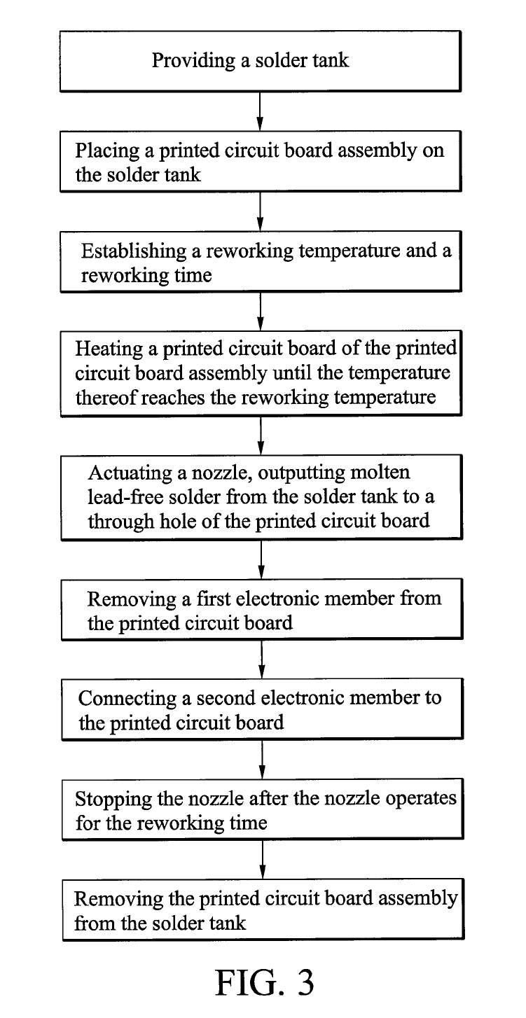

FIG. 3 is a flowchart showing the lead-free solder reworking method of the invention.

A solder tank comprising a nozzle and containing molten lead-free solder is provided, as shown in step 301. A printed circuit board assembly, which requires reworking, is placed on the solder tank, as shown in step 302. Specifically, the printed circuit board assembly has a printed circuit board and a first electronic member requiring replacement. The printed circuit board has a plurality of through holes. The first electronic member has a plurality of first pins respectively soldered in the through holes by means of lead-free solder. The through holes of the printed circuit board and first pins are located above the nozzle of the solder tank.

A reworking temperature and a reworking time are established in a controller, as shown in step 303. The controller actuates heaters, heating the printed circuit board until the temperature of the surface thereof reaches the reworking temperature, as shown in step 304.

The controller actuates the nozzle of the solder tank, and the nozzle outputs the molten lead-free solder to the through holes of the printed circuit board, melting lead-free solder in the through holes, as shown in step 305. The first electronic member is removed from the printed circuit board, as shown in step 306. A second electronic member is connected to the printed circuit board, as shown in step 307. Specifically, multiple second pins of the second electronic member are respectively fit into the through holes of the printed circuit board. At this point, the nozzle of the solder tank persistently outputs the molten lead-free solder into the through holes of the printed circuit board.

The controller stops the nozzle when the nozzle operates for the reworking time, as shown in step 308. At this point, the molten lead-free solder fills in the entire through holes. The reworked printed circuit board assembly is removed from the solder tank, completing a lead-free solder reworking process, as shown in step 309.

In conclusion, the disclosed lead-free solder reworking system and method provide the following advantages.

As the heaters or hot-air solder cleaning device heats the printed circuit board in advance, the molten lead-free solder does not solidify before thoroughly filling in the through holes of the printed circuit board. By establishing the reworking time, the layer of copper or copper film coated on the walls of the through holes of the printed circuit board is not damaged by long-term contact with the molten lead-free solder, thus protecting the conducting structure in the printed circuit board. Additionally, by establishing the reworking time, the printed circuit board does not excessively contact the molten lead-free solder, such that warping or deformation thereof is prevented.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A lead-free solder reworking method, comprising:
providing a solder tank comprising a nozzle and containing molten lead-free solder;
placing a printed circuit board assembly on the solder tank, wherein the printed circuit board assembly has a printed circuit board and a first electronic member, the printed circuit board has at least one through hole, the first electronic member has at least one first pin soldered in the through hole by lead-free solder, and the through hole and first pin are located above the nozzle;
establishing a reworking temperature and a reworking time;
heating the printed circuit board until the temperature thereof reaches the reworking temperature; and
actuating the nozzle, outputting the molten lead-free solder from the solder tank to the through hole of the printed circuit board until the nozzle operates for the reworking time.

2. The lead-free solder reworking method as claimed in claim 1, further comprising, after actuating the nozzle:
removing the first electronic member from the printed circuit board; and
connecting a second electronic member to the printed circuit board, wherein the second electronic member has at least one second pin fit into the through hole.

3. The lead-free solder reworking method as claimed in claim 1, further comprising providing a controller controlling the reworking temperature and reworking time.

4. The lead-free solder reworking method as claimed in claim 3, further comprising providing a heater heating the printed circuit board, wherein the heater is electrically connected to the controller.

5. The lead-free solder reworking method as claimed in claim 4, wherein the heater comprises a hot-air solder cleaning device.

6. The lead-free solder reworking method as claimed in claim 3, further comprising providing a temperature sensing member detecting the temperature of the printed circuit board, wherein the temperature sensing member is connected to the printed circuit board and electrically connected to the controller.

7. The lead-free solder reworking method as claimed in claim 6, wherein the temperature sensing member is connected to the surface of the printed circuit board.

8. The lead-free solder reworking method as claimed in claim 3, further comprising providing a monitor electrically connected to the controller.

9. A lead-free solder reworking system, comprising:
a controller;
a solder tank electrically connected to the controller and comprising a nozzle, wherein the solder tank contains molten lead-free solder;
at least one heater electrically connected to the controller, heating a printed circuit board assembly, wherein the printed circuit board assembly has a printed circuit board and a first electronic member, the printed circuit board has at least one through hole, the first electronic member has at least one pin soldered in the through hole by lead-free solder, and the through hole and pin are located above the nozzle; and
a temperature sensing member connected to the printed circuit board and electrically connected to the controller.

10. The lead-free solder reworking system as claimed in claim 9, wherein the heater comprises a hot-air solder cleaning device opposing the nozzle.

11. The lead-free solder reworking system as claimed in claim 9, wherein the temperature sensing member is connected to the surface of the printed circuit board.

12. The lead-free solder reworking system as claimed in claim 9, further comprising a monitor electrically connected to the controller.
